(19) United States
(12) Patent Application Publication
(10) Pub. No.: US 2020/0274560 A1
(43) Pub. Date: Aug. 27, 2020

(54) REAL-MODE DIGITAL PREDISTORTION

(71) Applicant: Analog Devices International Unlimited Company, Limerick (IE)

(72) Inventor: Patrick Pratt, Mallow (IE)

(21) Appl. No.: 16/802,160

(22) Filed: Feb. 26, 2020

Related U.S. Application Data
(60) Provisional application No. 62/810,758, filed on Feb. 26, 2019.

(51) Int. Cl. H04B 1/04; H04L 25/03

(52) U.S. Cl. CPC H04B 1/0475; H04B 2001/0425; H04L 25/03

(57) ABSTRACT

Various examples are directed to systems and methods for generating a real-mode predistorted signal. A digital predistortion (DPD) circuit may receive a real-mode signal comprising a linear portion and a nonlinear portion. The DPD circuit may generate a real-mode predistorted signal based at least in part on the real-mode signal.

### CLAIM OF PRIORITY

This application claims the benefit of priority to U.S. Provisional Patent Application No. 62/810,758, filed Feb. 26, 2019, which is incorporated by reference herein in its entirety.

### TECHNICAL FIELD

This document pertains generally, but not by way of limitation, to integrated circuits and communication systems, and particularly, but not by way of limitation to digital predistortion for power amplifiers.

### BACKGROUND

Radiofrequency (RF) communications, such as for mobile telephony, may use an RF power amplifier (PA) circuit in an RF transmitter to produce the RF signal for transmission over the air to an RF receiver. Cable communications circuits sometimes use a similar PA circuit. PA circuits used in RF communications and in cable communications have a nonlinear gain characteristic, such as gain compression, that occurs at higher power output levels. Nonlinear gain characteristics in the PA circuit can lead to signal distortion at such higher power levels.

U.S. Pat. No. 6,342,810, for example, mentions a method of compensating for amplifier nonlinearities by using predistortion to apply an inverse model of the amplifier's transfer characteristic to an input signal of the amplifier. A goal of such predistortion is to reduce distortion due to the PA circuit gain nonlinearity.

### SUMMARY

The present inventors have recognized, among other things, that allowing a power amplifier (PA) circuit to operate including in its nonlinear (e.g., gain compression) region, such as by using predistortion compensation, can provide one or more benefits, such as to improve amplifier efficiency and performance, reduce power consumption, reduce waste heat generation, and reduce or avoid the need for active or passive cooling of the PA circuit, but that using the PA circuit with wideband input signals may present additional challenges that that can increase distortion and noise in a PA circuit.

A PA circuit operated at least in part in its nonlinear region produces distortions across a wide frequency band. For example, when a PA circuit is used to amplify a carrier-modulated input signal, the PA circuit generates distortion terms centered at the carrier frequency and at harmonics of the carrier frequency. When the input signal has a bandwidth that is less than the carrier frequency, predistortion compensation may be used to correct for distortion terms centered at the carrier frequency, while distortion terms at the carrier frequency harmonics are removed by low-pass filtering. When the input signal is a wideband or ultrawide band signal with a bandwidth similar to or larger than the carrier frequency, however, the input signal frequency band may overlap with distortion terms at one or more of the carrier frequency harmonics. This may make it may difficult to use low-pass filtering to remove distortion terms without also degrading the input signal.

Among other things, this document explains how predistortion compensation can be used to correct distortion terms at the carrier frequency and to correct distortion terms at one or more carrier frequency harmonics. For example, the input signal may be and/or be converted to a complex signal (e.g., a complex baseband signal). A real-mode DPD circuit may convert the complex baseband signal to a real signal and generate a predistorted signal from the real signal.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example of a power amplifier (PA) system with real-mode digital predistortion (DPD).

FIG. 2 shows one example of the PA circuit of FIG. 1 showing additional details of the real-mode DPD circuit.

FIG. 3 is a diagram showing bandwidth expansion in an example of the nonlinear DPD circuit.

FIG. 4 is a diagram of an example of the PA circuit of FIG. 1 including additional details of the nonlinear DPD circuit.

FIG. 5 is a diagram showing an example of the nonlinear DPD circuit including additional details of the complex-to-real circuit.

FIG. 6 is a diagram showing an example of the PA circuit of FIG. 1 showing the real DPD circuit implemented with a look-up table (LUT) bank.

FIGS. 7A and 7B are a diagram showing an example of a Finite Impulse Response (FIR) filter that may be used to implement the real DPD circuit in addition to or instead of the LUT bank of FIG. 6.

FIG. 8 is a diagram showing an example of the PA circuit of FIG. 1 including additional details of the training circuit.

FIG. 9 is a diagram showing one example of the PA circuit of FIG. 1 including a cable uptilt circuit.

FIG. 10 is a diagram showing an example of a configuration setup of a PA circuit for training the tilt equalizer.

FIGS. 11A and 11B is a diagram showing one example of the PA circuit of FIG. 1 including a cable uptilt circuit and another example of a training circuit.

FIGS. 12 and 13 are a diagram showing the PA circuit of FIG. 1 in the example configuration of FIG. 9 including modeled power spectral densities at various positions in the circuit.

FIG. 14 is a diagram showing an example implementation of the nonlinear DPD circuit including an alternate component configuration.

### DETAILED DESCRIPTION

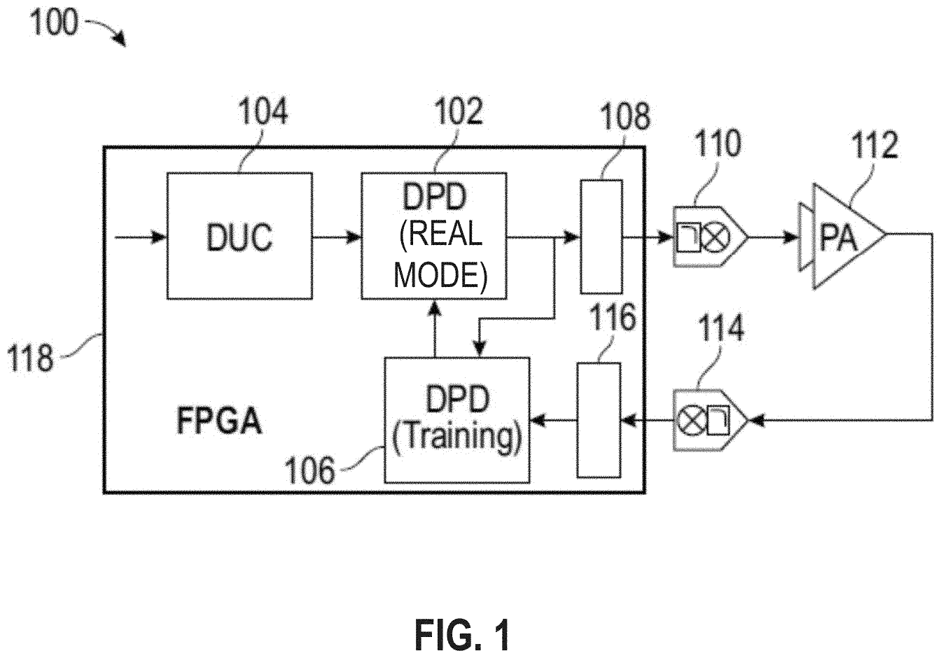

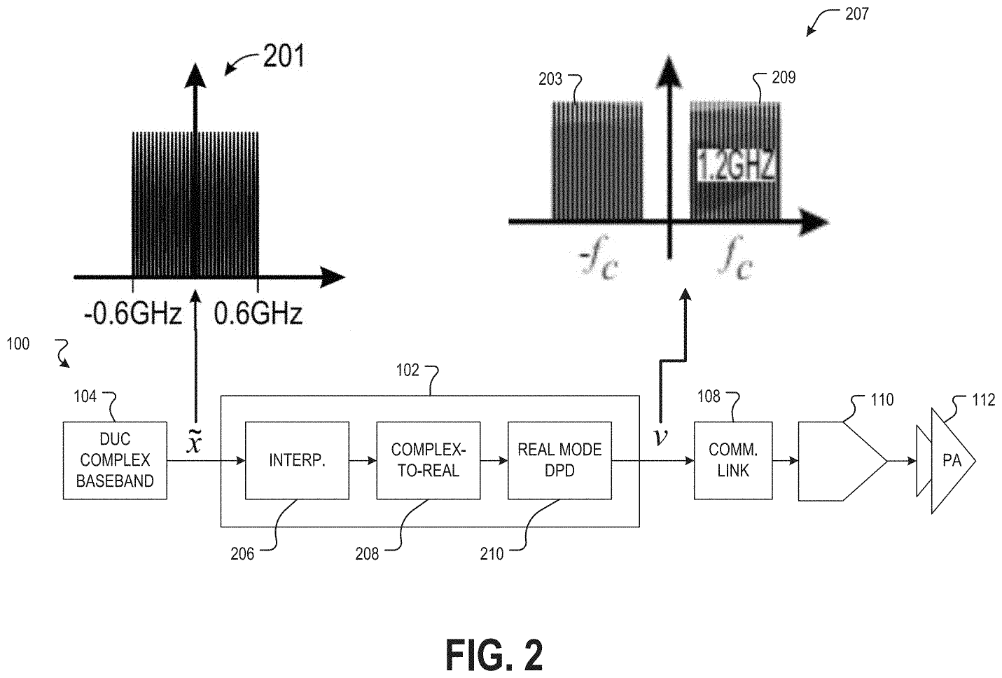

FIG. 1 shows an example of a power amplifier (PA) circuit 100 with real-mode digital predistortion (DPD). The circuit 100 may be utilized in different applications including, for example, for RF transmission, such as cellular network transmissions, and/or for transmissions through a cable (e.g., a coaxial cable) of a cable television network or similar network. A real-mode digital predistortion (DPD) circuit 102 may receive as an input signal a complex baseband signal \tilde{x}. (The Digital Upconverter (DUC) 104, which may be positioned upstream of the DPD circuit 102, is described in more detail below.) The complex baseband signal \tilde{x} may be a complex or analytic signal having a real component and a quadrature component. The DPD circuit 102 may generate a predistorted signal v. For example, the DPD circuit 102 may include a complex-to-real circuit 208 (FIG. 2) for converting the complex baseband signal \tilde{x} to a real signal. The predistorted signal v may be provided to a digital-to-analog converter (DAC) 110 (e.g., via a communications link 108). In some examples, the DAC 110 may also modulate the predistorted baseband signal v to a carrier frequency f_{c} to generate a transmission signal, although in other examples a separate up-converter component may be used. The transmission signal may be provided to a power amplifier 112, such as for wireless or wired transmission. In some examples described herein, the DPD circuit 102 operates at the carrier frequency f_{c} and provides the predistorted signal v at the carrier frequency.

A DPD adaptation or training circuit 106 may train the DPD circuit 102, for example, as described herein. An output of the PA 112 may be sampled by an analog-to-digital converter (ADC) 114 to generate a feedback signal y. In the example shown in FIG. 1, the ADC 114 also down-converts the sampled output of the PA 112 to baseband, although in other examples a separate down-converter component may be used. The ADC 114 may provide the feedback signal y to the DPD training circuit 106, (e.g., via the communications link 116). The DPD training circuit 106 may also receive the predistorted baseband signal v. Based on the predistorted baseband signal v and the baseband feedback signal y, the DPD adaptation circuit 106 may generate and/or update the DPD circuit 102. Additional examples for training the DPD circuit 102 are described herein.

In the example of FIG. 1, the complex baseband signal \tilde{x} is received by the DPD circuit 102 from a digital up-converter (DUC) 104. The DUC 104 may be used in various applications, such as cable applications. For example, the DUC 104 may receive a set of channel signals. Each channel signal may be a complex signal centered at baseband. In some cable communication applications, each channel signal represents one television channel. The DUC 104 stacks the channel signals to generate the complex baseband signal. In a simple example, the DUC 104 receives four channel signals, each having a bandwidth B, and each centered at a frequency B/2. The first channel signal may remain centered at B/2. The DUC 104 may translate the second channel signal to generate a translated second channel signal centered at 3B/2. The DUC 104 may translate the third channel signal to generate a translated third channel signal centered at 5B/2 and may translate the fourth channel signal to generate a translated fourth channel signal centered at 7B/2. The DUC 104 may combine the first channel signal, the translated second channel signal, and the translated third channel signal to generate the complex baseband signal. The resulting complex baseband signal may have a bandwidth of 4B. Although this example includes four channel signals, more or fewer channel signals may be acted 20 on by the DUC 104. Also, although the channel input signals received by the DUC 104 are described as being received at the DUC 104 in complex baseband, in some examples, the DUC 104 may receive real channel signals and convert the real channel signals to the complex baseband signal output. Also, in some examples, the output of the DUC 104 may be expressed as a real signal and may be converted to complex form by a subsequent circuit component. In some examples, the DUC 104 is omitted. In some examples, the DUC 104 is a real-mode DUC that produces a real-mode signal, such as a real-mode baseband signal. In these examples, the complex-to-real circuit 208 (FIG. 2) of the real-mode DPD circuit 102 may be omitted.

The example of FIG. 1 shows a configuration of the circuit 100 implemented utilizing a Field Programmable Gate Array (FPGA) 118. For example, the DUC 104, DPD circuit 102, and DPD training circuit 106 are shown implemented by the FPGA 118. Components or modules not implemented by the FPGA 118 in FIG. 1 may be implemented using any other suitable hardware. The communications links 108, 116 shown in FIG. 1 may be used to facilitate communications between the FPGA 118 and the various other components of the circuit 100. The communications links 108, 116 may be configured according to any suitable protocol, such as the JESD204 serial protocol. Although the communications links 108, 116 are shown on the FPGA 118, in some examples, communications protocols 108, 116 may be implemented with different hardware components. Also, in some examples, the DPD adaptation circuit 106 may be implemented off of the FPGA 118, such as at a separate digital signal processor (DSP) (not shown). For example, the DPD adaptation circuit 106 may train the DPD circuit 102 at a clock rate slower than the operation of the DPD circuit 102 allowing the DPD adaptation circuit 106 to be implemented on a slower DSP rather than the FPGA 118. Although the example of FIG. 1 is shown on an FPGA, in some examples, some or all of the components shown in FIG. 1 can be implemented in different ways such as, for example, using an Application Specific Integrated Circuit (ASIC) or other suitable component.

FIG. 2 shows an example of the PA circuit 100 of FIG. 1 showing additional details of the real-mode DPD circuit 102. The DPD circuit 102 may receive the complex baseband signal \tilde{x} and provide as output a predistorted signal v. Additional details of the DPD circuit 102 are provided herein.

In some examples, the use of a real-mode DPD circuit 102 provides several advantages over alternate arrangements. For example, real-mode processing of the nonlinear correction terms by the DPD circuit 102 may enable the correction of wide bandwidth complex baseband signals. In some examples, wide bandwidth complex baseband signals may include complex baseband signals having a bandwidth that is about equal to the carrier frequency and/or complex baseband signals where the lower band edge is less than or equal to about half of the upper band edge and/or at or close to direct current (DC) (e.g., ƒ=0). For example, real-mode processing at the DPD circuit 102 may provide correction for multiple distortion orders across multiple harmonic frequency zones of the carrier frequency.

Processing both the linear and non-linear portions of the complex baseband signal \tilde{x} in real-mode also provides certain advantages. For example, a real-mode DPD circuit 102 such as the one shown in FIG. 2 may not need separate linear and non-linear DPD sub-circuits, which reduces the complexity of the PA circuit 100. Also, several potential disadvantages of processing both linear and non-linear portions of the complex baseband signal \tilde{x} are offset or overcome by corresponding advantages. For example, converting the full complex baseband signal \tilde{x} to real-mode, including both linear and non-linear portions, may add complexity to the complex-to-real circuit 208 related to implementations where only the non-linear portion of the complex baseband signal \tilde{x} is converted to real-mode. For example, a complex-to-real circuit that converts only a non-linear portion of the complex baseband signal \tilde{x} may include an interpolation filter with fewer taps than the interpolation filter of the complex-to-real circuit 208 that converts the full complex baseband signal \tilde{x}, including linear and non-linear components. This additional complexity, however, can be offset or overcome because, in some examples, a real-mode DPD circuit 102 may not need to utilize a real-to-complex circuit or decimator at the output of the DPD circuit 102 to facilitate recombination with the linear portion of the signal.

The DPD circuit 102 receives the complex baseband signal \tilde{x} and provides as output a predistorted signal v. In some examples, such as cable implementations, the predistorted signal v may be decimated or otherwise of its sample rate dropped to the same rate as the complex baseband signal \tilde{x}, for example, to facilitate transmittal via the communication link 108. The DPD circuit 102 may operate in real-mode and, in some examples, at the carrier frequency f_{c}. For example, the DPD circuit 102 may comprise circuits for converting the complex baseband signal \tilde{x} to real-mode, modulating the complex baseband signal \tilde{x} to the carrier frequency f_{c} and/or performing other processing. FIG. 2 shows various constituent circuits of the DPD circuit 102 including an interpolator circuit 206, a complex-to-real converter circuit 208, and a DPD actuator circuit 210.

FIG. 2 also includes plots of examples of the various signals in the circuit 100. A plot 201 shows one example of the complex baseband signal \tilde{x}. In the example of FIG. 2, the complex baseband signal \tilde{x} has a bandwidth of about 1.2 GHz, extending from −0.6 GHz to 0.6 GHz. A plot 207 shows the predistorted signal v including an image 209 having a bandwidth of about 1.2 GHz centered at the carrier frequency and an image 203 centered at the negative carrier frequency.

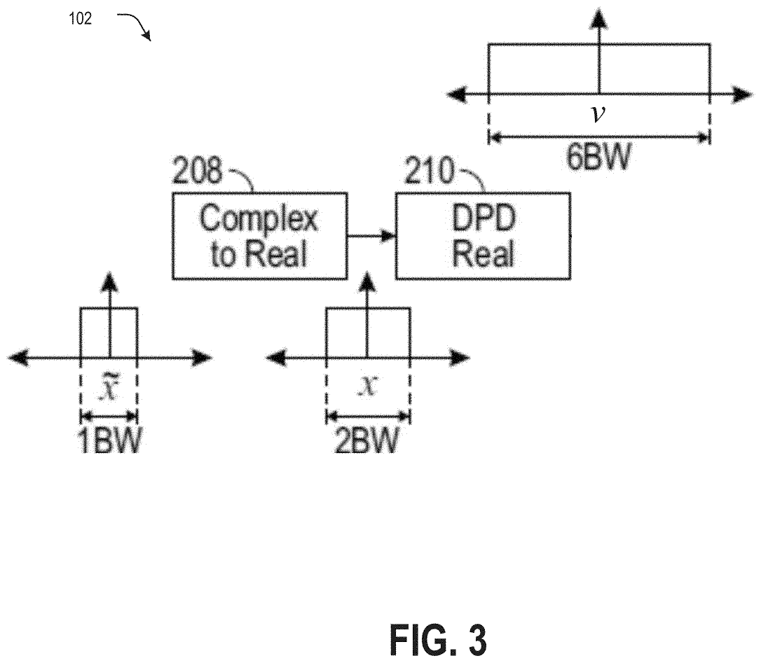

FIG. 3 is a diagram showing bandwidth expansion in an example of the DPD circuit 102. FIG. 3 shows the complex-to-real circuit 208 and the DPD actuator circuit 210. The complex baseband signal \tilde{x} may have an initial bandwidth indicated in FIG. 3 as BW. The initial bandwidth may be any suitable bandwidth. For example, the initial bandwidth may be a wideband or ultrawideband bandwidth within an order of magnitude of the carrier frequency f_{c}. In the example of FIG. 2, the plot 201 of the complex baseband signal has an initial bandwidth of 1.2 GHz, although complex baseband signals of other bandwidths may be used. In another example cable communication implementation, the bandwidth of the complex baseband signal \tilde{x} can be higher, such as about 4 GHz or, in some examples, about 4.2 GHz.

The various components of the DPD circuit 102 may expand and contract the bandwidth of the processed signals. Converting the complex baseband signal \tilde{x} to real-mode at complex-to-real circuit 208 may generate a real signal x with double the original bandwidth BW, or 2BW. The real signal x, in some examples, may be translated to the carrier frequency f_{c} prior to processing by the DPD actuator circuit 210. For example, converting the complex baseband signal \tilde{x} to real-mode may introduce negative frequency content that can double the original bandwidth BW. The DPD actuator circuit 210 may further expand the bandwidth of the real signal x. For example, the predistorted signal v may have a bandwidth greater than the bandwidth of the real signal x by a factor equal to the highest order distortion term compensated by the DPD actuator circuit 210. In the example of FIG. 3, the highest order distortion term to be compensated is of the 3^{rd} order. Accordingly, the DPD actuator circuit 210 may generate a predistorted signal v with a bandwidth of about three times the bandwidth of the real signal x, or about 6BW.

Bandwidth expansion in the DPD circuit 102 may increase the desirable sample frequency fₛ in the circuit 204. The sample frequency fₛ (also sometimes referred to as the sample rate) may refer to the number of samples n of the various signals per unit time. Under the Nyquist theorem, the maximum signal frequency that can be accurately reconstructed from a digital signal is equal to the sampling frequency fₛ, for complex signals, and equal to ½ of the sampling frequency (fₛ/2) for real signals. Accordingly, if the bandwidth of the signals processed by the DPD circuit 102 is expanded to include frequency content at greater than the Nyquist frequency, then aliasing and/or other distortion may be introduced unless the sample frequency fₛ (and hence the Nyquist frequency) is also increased. Referring again to FIG. 2, the interpolator circuit 206 may be configured to increase the sampling frequency fₛ of the complex baseband signal \tilde{x} to allow for bandwidth expansion in the DPD circuit 102 without excessive aliasing or distortion. The interpolator circuit 206 may increase the sampling frequency to two times the highest expected frequency content.

In various examples, the highest expected frequency content in the nonlinear DPD circuit may be highest order distortion term to be corrected. For example, if the highest order distortion term to be corrected is three (e.g., 3^{rd} order), the interpolator circuit 206 may increase the sampling frequency by a factor of 2*3, or 6. In some examples, distortion terms with an order higher than a selected order (e.g., the 3^{nd} order) may drop off significantly in magnitude so as to be below the noise floor of the PA circuit 100. Accordingly, in some examples, the interpolator circuit 206 may be configured to increase the sampling frequency of the complex baseband signal \tilde{x} by a factor of six (6), or other suitable order, even if higher order distortion terms are to be considered. The interpolator circuit 206 may be implemented using any suitable technology such as, for example, Cascaded Integrator-Comb (CIC) or Hogenauer filtering, half-band filtering, polyphase filtering, etc.

In some examples, the real-mode DPD circuit 102 is advantageous in implementations, such as cable communication implementations, in which the fractional bandwidth of the complex baseband signal \tilde{x} is high. The fractional bandwidth of a signal is the bandwidth divided by the carrier frequency. Consider an example for which the bandwidth of the complex baseband signal \tilde{x} is about 100 MHz and the carrier frequency f_{c} is about 1 GHz. In this example, the fractional bandwidth is about 1/10. Now consider another example in which the bandwidth of the complex baseband signal \tilde{x} is about 1.2 GHz, as shown in the plot 201 of FIG. 2, and the carrier frequency f_{c} is about 600 MHz. In this example, the fractional bandwidth is about 2 because the bandwidth is about twice the carrier frequency fₒ. Also, in this example, the lower edge of the complex baseband signal \tilde{x} is near direct current (DC).

Because of the high fractional bandwidth of the complex baseband signal \tilde{x}, harmonics of the lower channels of the complex baseband signal \tilde{x} fall within the signal bandwidth. This means that higher-order harmonic distortion terms (e.t., 3^{rd}, 4^{th}, 5^{th}, 6^{th}, 7^{th}, and so on) may appear within the bandwidth of the complex baseband signal \tilde{x}. As a result, it may be desirable to correct for these higher-order terms with the DPD circuit 102. As described herein, however, correcting for higher-order terms with a DPD results in bandwidth expansion. Utilizing a real-mode DPD circuit 102, as described herein may reduce the bandwidth expansion for the reasons described. The advantages of real-mode DPD can be apparent, for example, when the complex baseband signal \tilde{x} has a fractional bandwidth greater than about ½ including, for example, between about ½ and 3, between about 1 and 2, etc.

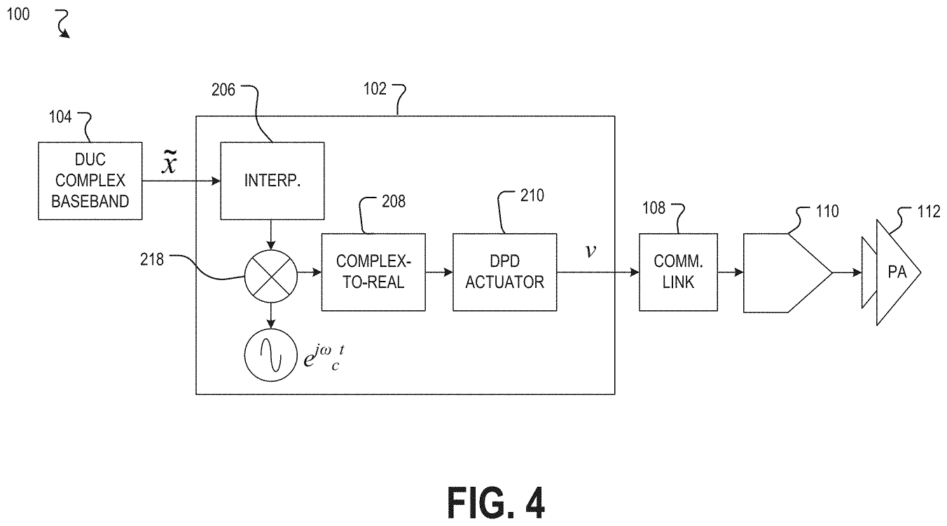

FIG. 4 is a diagram of an example of the PA circuit 100 including additional details of the DPD circuit 102. In the example of FIG. 4, the DPD circuit 102 may include a DPD actuator circuit 210 that operates at the carrier frequency f_{c}. Accordingly, the complex baseband signal \tilde{x} may be translated to the carrier frequency f_{c} at a mixer 218 to generate a translated complex signal. Up-conversion may be accomplished, for example, by multiplying the complex baseband signal \tilde{x} by a complex representation of the carrier frequency, given by [1]:

e^{jω}^{_{c}}^{t} [1]

In [1], ω_{c} may be the angular representation of the carrier frequency f_{c}. For example, ω_{c} may be equal to 2πf_{c}. The predistorted signal v may remain at the carrier frequency f_{c} for transmission at the power amplifier 112. In FIG. 4, translation to the carrier frequency occurs after the interpolator circuit 206. In some examples, however, translating may occur prior to the interpolator circuit 206.

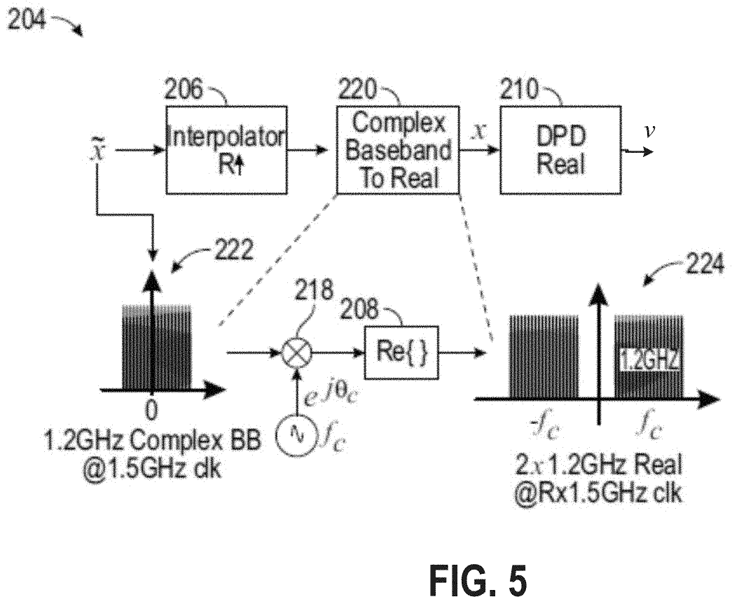

FIG. 5 is a diagram showing an example of the DPD circuit 102 including additional details of the complex-to-real circuit 208. In the example of FIG. 5, the complex-to-real circuit 208 and the mixer 218 are combined into a complex baseband-to-real circuit 220. FIG. 5 includes a plot 222 showing one example of the complex baseband signal \tilde{x}. The example plot 222, similar to the example plot 201, has a bandwidth of 1.2 GHz centered at DC. Mixer 218 may translate the complex baseband signal \tilde{x} to the carrier frequency, resulting in a 1.2 GHz bandwidth signal centered at f_{c}. The complex-to-real circuit 208 may generate the real signal x, which may have a 1.2 GHz frequency component centered at f_{c} and a 1.2 GHz frequency component centered at −f_{c} as shown by plot 224.

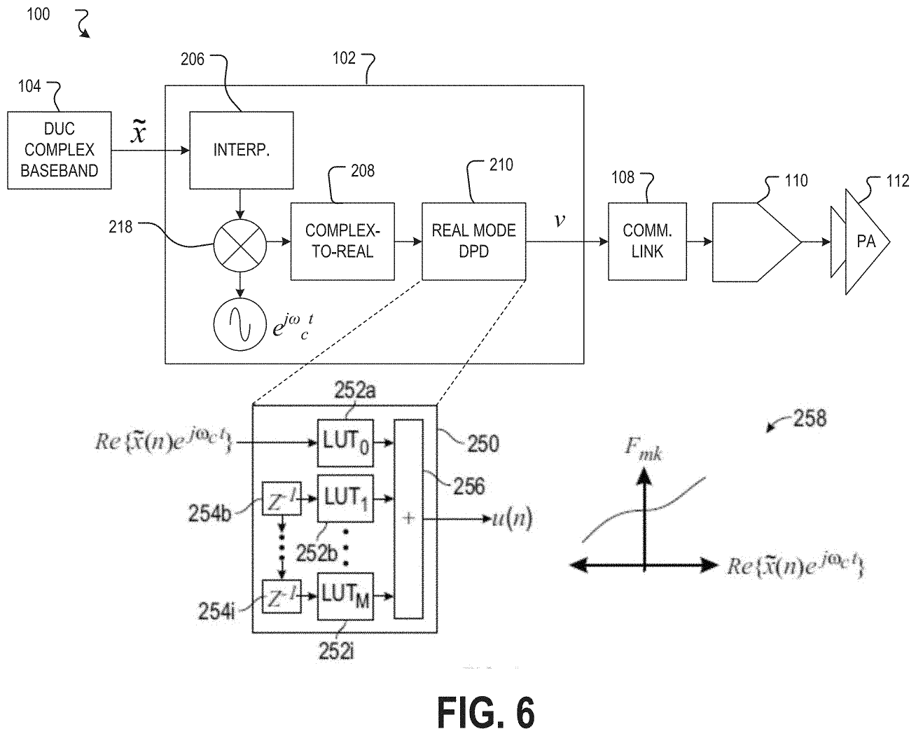

FIG. 6 is a diagram showing an example of the PA circuit 100 showing the DPD actuator circuit 210 implemented with a look-up table (LUT) bank 250. The DPD actuator circuit 210, as described herein, may receive a real signal x(n) that is a real component of the complex baseband signal \tilde{x} translated to the carrier frequency f_{c}, for example, represented by [2]:

x(n)= [symbol] e{\tilde{x}(n)e^{jω}^{_{c}}^{t}} [2]

The LUT bank 250 may comprise M LUTs 252a, 252b, 252i, where M is the memory depth of the LUT bank 250. For example, the LUT bank 250 may determine a value x(n) at a first sample it. The value may be used as an index to select a value from a first LUT 252a. The value for x(n) may be provided to a cascade of delay circuits 254b, 254i, which may generate delayed values of x that may be provided to LUTs 252b, 252i at different memory levels. For example, the output of LUT 252b may be based on x(n−1) and the output of LUT 252i may be based on x(n−M). The values for each of the M+1 LUTs 252a, 252b, 252i may be summed at summer 256 to yield the predistorted nonlinear component u. Example values for the LUTs as a function of x(n) are shown by a plot 258.

A general expression for a DPD predistorted signal may be given by Equation [3] below:

v(n)=Σₘ₌₀^{M}Σₖ₌₀^{K}hₖ(m)x(n−m)^{k} [3]

Equation [3] represents a memory polynomial approximation of a general Volterra series. In some examples, the Volterra series itself, or other suitable approximations may be used. In Equation [3], v is the predistorted signal, M is the memory depth, hₖ(m) is a coefficient of the memory polynomial or other model of the distortion caused by the PA 112. The coefficient hₖ(m) may be a function of k, which is the order of the term corrected, and m, which is the memory depth. Mmay be the highest memory depth of the correction, and K may be the highest order distortion term to be corrected. From Equation [3], a one-dimensional look-up function [symbol] _{mK} may be derived, as indicated by Equation [4] below:

$${ℱ}_{mK} \{ x ( n - m ) \} = {\sum }_{k = 0}^{K} {h}_{k} ( m ) {x ( n - m )}^{k} \qquad [ 4 ]$$

Accordingly, each look up table (LUT) value [symbol] _{mK} at a given memory depth m may be based on a sum over all corrected distortion orders of the product of order-specific coefficients and the real component value at the memory depth. A predistorted signal v(n) may be found by summing the outputs of the M+1 LUTs, as given by Equation [5] below:

$$v ( n ) = {\sum }_{m = 0}^{M} {ℱ}_{m K} \{ x ( n - m ) \} \qquad [ 5 ]$$

For a real-mode real DPD circuit, such as 210, the linear memoryless term of v(n) may be omitted to generate the predistorted nonlinear component u(n), which may be given by [6] below:

u(n)=v(n)−h₁(0)x(n) [6]

To remove the linear memoryless term from the LUT bank 250, in some examples, the output of the memoryless LUT 252a may be modified from the general form given by Equation [4] above to the form given by Equation [7] below:

$${ℱ}_{0 K} \{ x ( n ) \} = {h}_{0} + {\sum }_{k = 2}^{K} {h}_{k} ( m ) {x ( n )}^{k} \qquad [ 7 ]$$

Accordingly, values from the memoryless LUT 252a may omit first order terms from the indicated sum. Correction for first order terms may be affected, for example, by the linear DPD circuit 202. Additional LUTS 252b, 252i may be configured, for example, as set forth about in Equation [4].

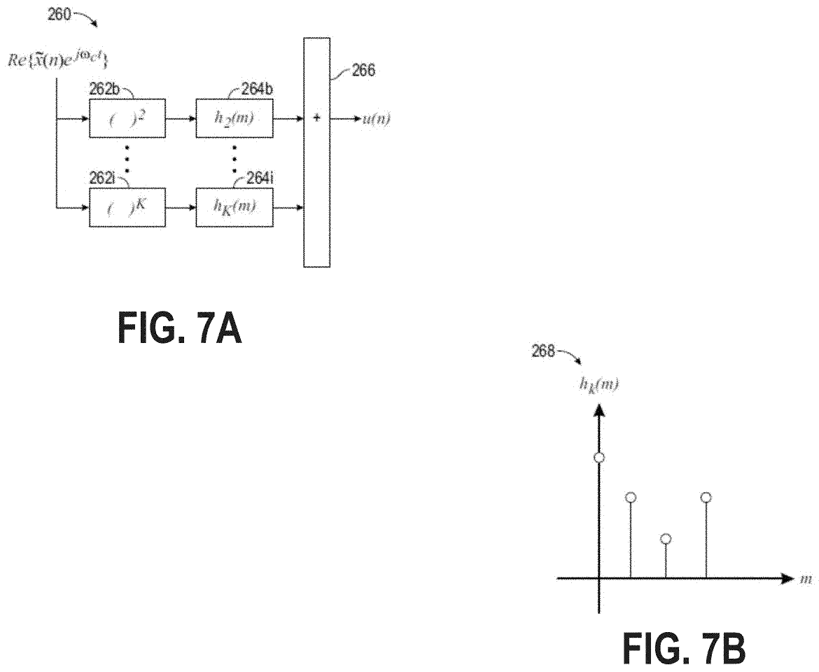

FIGS. 7A and 7B are a diagram showing one example of a Finite Impulse Response (FIR) filter 260 that may be used to implement the DPD actuator circuit 210 of the DPD circuit 102 in addition to or instead of the LUT bank 250. The FIR filter 260 may comprise taps 264b, 264i. The number of taps 264b, 264i may depend on the memory depth M of the DPD actuator circuit 210. Each tap 264b, 264i may receive an output of a corresponding delay circuit 254b, 254i that may raise a current value of the real signal x to a power corresponding to the order of the tap 264b, 264i. As shown, a first order tap (e.g., a tap with coefficient h₁(m)) is omitted to generate the predistorted nonlinear component u. Example values for the taps 264b, 264i as a function of memory depth m are shown by plot 268. In the example shown in FIGS. 7A and 7B, no first order or linear FIR filter is included in the DPD actuator circuit 210. In some examples, a linear FIR may be included, but the linear FIR may omit its zero memory tap.

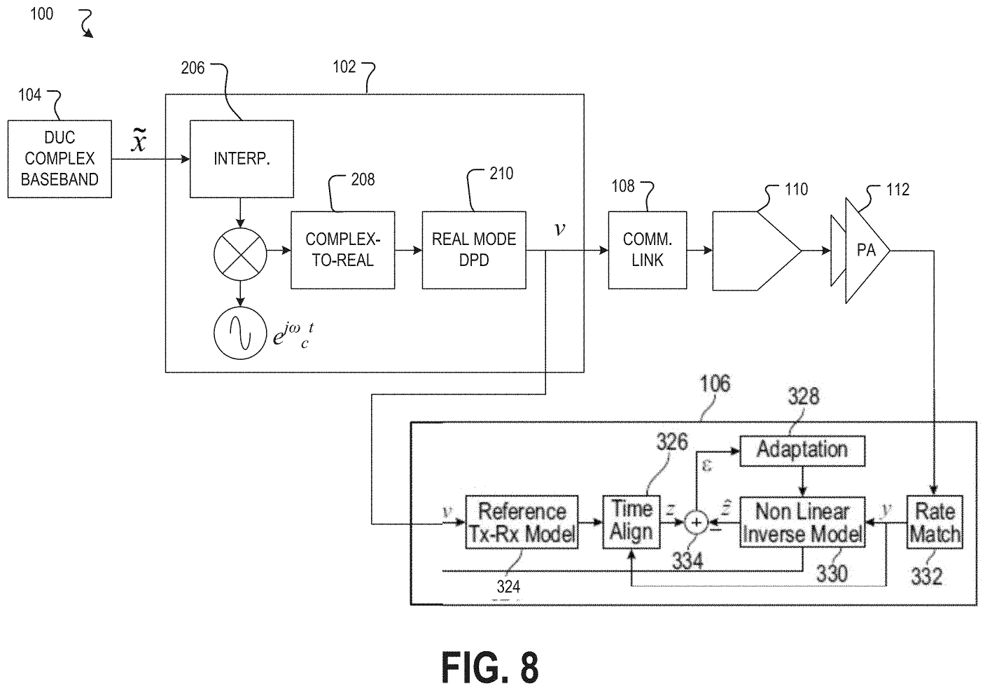

FIG. 8 is a diagram showing one example of the PA circuit 100 including additional details of the training circuit 106. The example training circuit 106 shown in FIG. 8 operates in real-mode by comparing the real predistorted signal v to the feedback signal y. For example, the training circuit 106 may receive the predistorted signal v. A reference model filter circuit 324 and time alignment circuit 326 may be applied to the real predistorted signal v to emulate the PA 112 and align the reference output z with the feedback signal y.

The feedback signal y may be processed by a rate match circuit 332 to increase its sampling frequency to match the sampling frequency of the input signal x and the real predistorted signal v. The rate-matched feedback signal may be provided to a nonlinear inverse model circuit 330. The nonlinear inverse model circuit 330 may generate an actual output \hat{z}. A difference circuit 334 may find a difference a between the actual output \hat{z} and the reference output z. The difference a may be provided to an adaption circuit that, in conjunction with the nonlinear inverse model circuit 330, may generate a coefficient vector h. A linear, memoryless term h₁(0) of the matrix h may be provided to the linear DPD circuit 202. The other coefficients of the coefficient vector h may be provided to the DPD actuator circuit 210 to be used as FIR filter coefficients and/or to a LUT construction circuit 320, which may utilize the coefficient matrix A to generate LUTs 252a, 252b, 252i, for example, as described above with respect to Equation [7].

The real-mode DPD circuit 102 described herein may be used for RF transmission and/or higher bandwidth cable implementations. In some examples where the real-mode DPD circuit 102 is used for cable implementations, a cable uptilt circuit 350 positioned prior to the PA 112 may apply an “uptilt” frequency modification to the predistorted signal v. The uptilt frequency modification may compensate for frequency dependent signal loss exhibited by some cables. For example, a cable may exhibit a high frequency rolloff characteristic of about 2 dB of signal amplitude reduction per 100 MHz of frequency, such as at frequencies above 50 MHz. The uptilt frequency modification may amplify higher frequency portions of the signal that are attenuated by the cable so as to reduce frequency-dependent distortions at the signal destination.

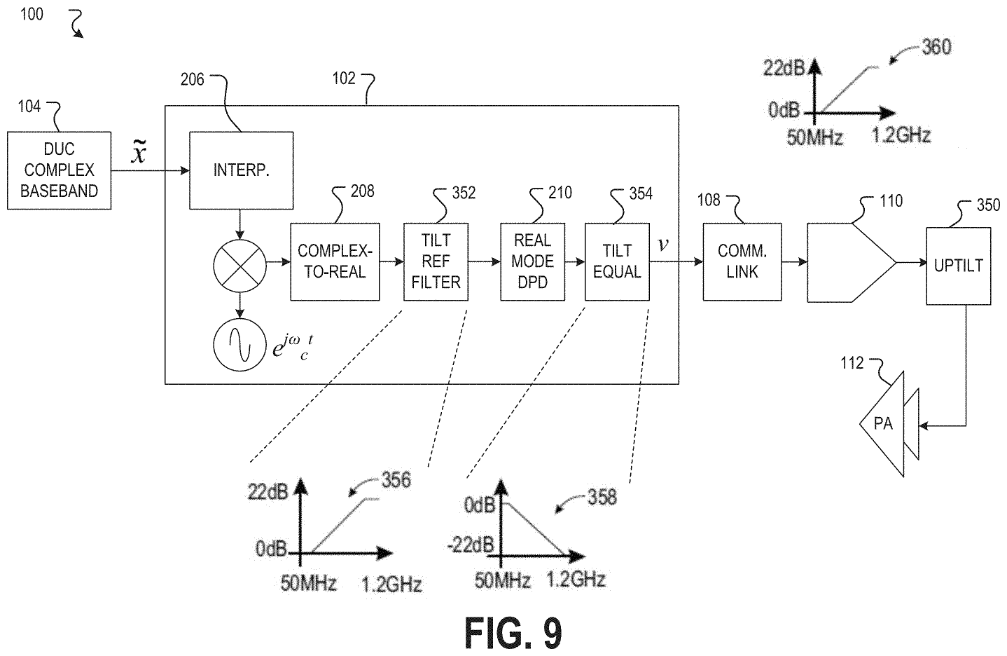

FIG. 9 is a diagram showing an example of the PA circuit 100 including a cable uptilt circuit 350. The cable uptilt circuit 350 may be an analog circuit positioned prior to the PA 112 and configured with a highpass frequency gain expansion characteristic, for example to compensate for high frequency rolloff characteristic of a cable or other transmission medium downstream of the PA 112. For example, the cable uptilt circuit 350 may have a highpass frequency gain expansion characteristic of about +2 dB/100 MHz, for example, shown by plot 360.

In the example of FIG. 9, the DPD circuit 102 may also include a tilt reference filter circuit 352 positioned prior to the DPD actuator circuit 210 and a tilt equalizer circuit 354 positioned after the DPD actuator circuit 210. For example, absent the tilt reference filter circuit 352 and tilt equalizer circuit 354, the DPD circuit 102 may tend to counteract the cable uptilt circuit 350. The tilt reference filter circuit 352 may include a frequency response that can be specified and set to match a desired uptilt observed at the output of the PA circuit 100. Like the analog uptilt circuit 350, the digital uptilt filter circuit 352 can provide a highpass frequency gain expansion characteristic (e.g., +2 dB/100 MHz amplification for frequencies exceeding 50 MHz) of a cable to offset or compensate for the lowpass frequency dependent signal loss of the cable. This is illustrated by the plot 356, which shows a +2 dB/100 MHz gain characteristic for frequencies above 50 MHz.

The tilt equalizer circuit 354 may be may include a digital equalizer having a frequency modification setting that has a lowpass filter characteristic, such as shown in plot 258, such as approximately −2.2 dB/100 MHz for frequencies above 50 MHz, which may be approximately the inverse of the frequency modification provided by the digital tilt reference filter circuit 352 and analog uptilt circuit 350. The particular frequency modification to be provided by the equalizer circuit 354 can be selected to compensate for or eliminate the effect of the analog uptilt circuit 350 interposing a frequency dependent uptilt gain and group delay variation between the DPD actuator circuit 210 and the PA 112. The particular frequency modification provided by the tilt equalizer circuit 354 may be selected to provide a substantially constant gain versus frequency, a substantially constant group delay versus frequency or both, such as at the output of the tilt equalizer circuit 354. In some examples, the tilt equalizer circuit 354 may also be configured to correct for other frequency dependent artifacts resulting, for example, from low pass filtering, and decimation. The tilt reference filter circuit 352 and tilt equalizer circuit 354 may be run in real-mode at the up-sampled sampling frequency of the DPD circuit 102.

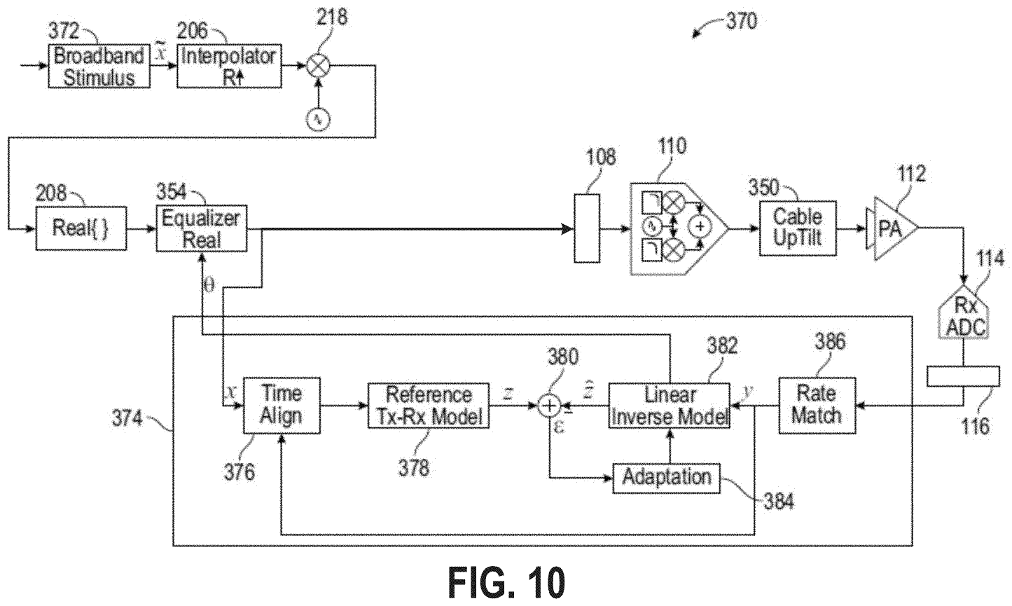

FIG. 10 is a diagram showing one example of a configuration setup 370 of a PA circuit for training the tilt equalizer 354. A broadband stimulus circuit 372 may generate a broadband stimulus signal indicated in FIG. 10 by \tilde{x}. The broadband stimulus signal may be provided to the interpolator circuit 206, mixer 218, and complex-to-real converter circuit 208, for example, as described herein, to generate a real signal x. The tilt equalizer 354 may receive the real-mode signal x. An output of the tilt equalizer 354 may be provided to the DAC 110, analog cable uptilt filter 350 and PA 112, for example, via the communication link circuit 108.

An uptilt training circuit 374 may generate a tap coefficient vector θ of tap coefficients θᵢ for the uptilt equalizer circuit 354. For example, an output of the uptilt equalizer circuit 354, indicated in FIG. 10 by x, may be used to generate a reference output z. A time alignment circuit 376 and reference model circuit 378 may act on the uptilt equalizer output x to generate the reference output z. Similarly, the feedback signal y may be rate matched to the up-sampled sampling frequency of the interpolator circuit 206 by rate match circuit 332. Linear inverse model circuit 382 may receive the feedback signal y and generate an actual output \hat{z}. A difference circuit 380 may receive the reference output z and actual output \hat{z} and, in conjunction with the linear inverse model circuit 382, generate the tap coefficient vector θ.

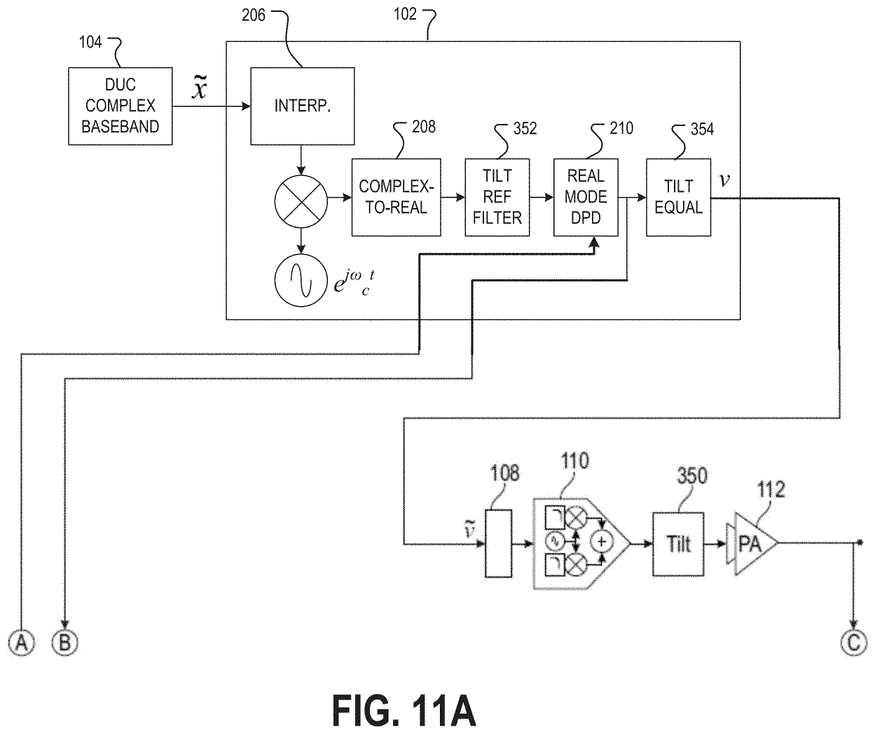

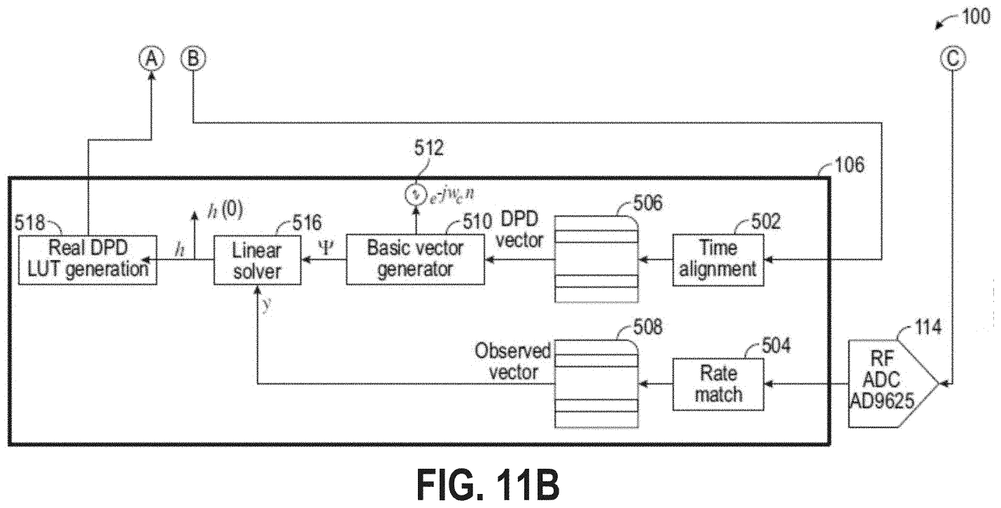

FIGS. 11A and 11B are a diagram showing one example of the PA circuit 100 of FIG. 1 including a cable uptilt circuit 350 and another example of a training circuit 106. The training circuit 106 is another example of a training circuit that may be used, in some examples, in place of the training circuit 106 shown in FIG. 8. The DPD circuit 102 shown in FIGS. 11A and 11B may be similar to the DPD circuit 102 as configured in FIG. 9 with the tilt reference filter 352 and tilt equalizer 354 positioned and the cable uptilt circuit 350 as shown.

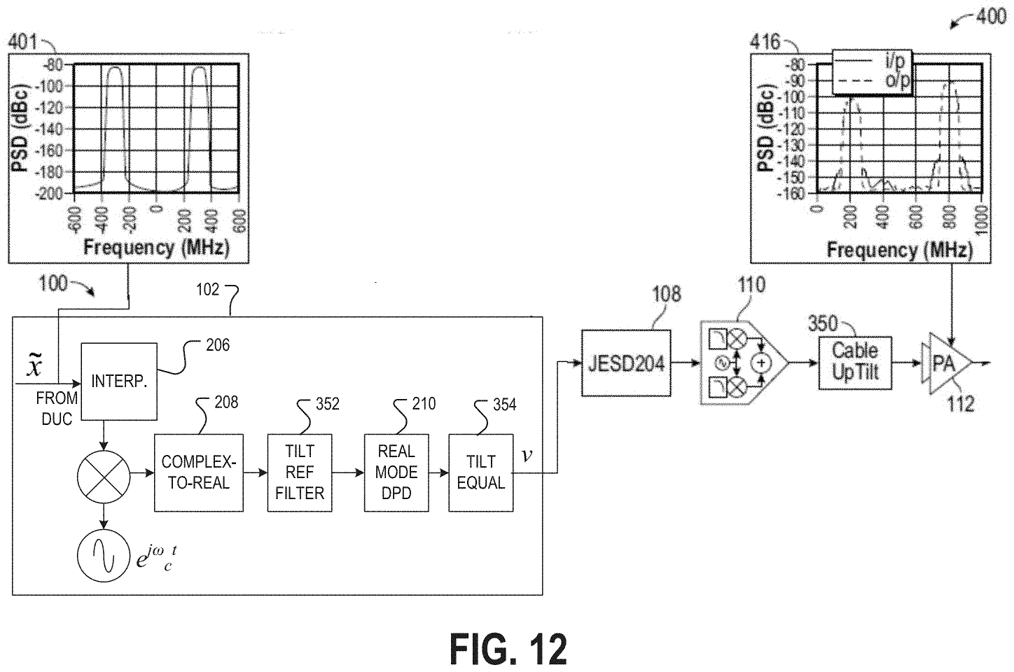

The configuration of the training circuit 106 shown in FIGS. 11A and 11B receives an output of the power amplifier 112, for example, via ADC 114. In some examples, a communication link, such as 116 in FIG. 12, may also be included. The training circuit 106 may also receive an output of the DPD actuator circuit 210. A time alignment circuit 502 and rate match circuit 504 may match the timing and the sampling frequencies of the output of the DPD actuator circuit 210 and the output of the power amplifier 112. For example, propagation delays from the components of the nonlinear DPD circuit, the power amplifier 112 and other various components may cause the output of the power amplifier 112 to be delayed relative to the output of the DPD actuator circuit 210. Also, as described herein, the sampling frequency after the interpolator 206 and before the tilt equalizer 354 (e.g., where the output of the DPD actuator circuit 210 is taken) may be higher than the sampling frequency at the ADC 114. For example, the sampling frequency at the ADC may match the sampling frequency of the complex baseband signal.

Values for the output of the DPD actuator circuit 210 and the power amplifier 112 may be stored at respective memory buffers 506, 508. For example, memory buffer 506, which receives the output of the DPD actuator circuit 210, may provide to a basis vector generation circuit 510 a DPD vector constructed from values of the output of the DPD actuator circuit 210 stored at the memory buffer 506 over time. The basis vector generation circuit 510 may shift the DPD vector by the carrier frequency 512 to generate a basis vector matrix, represented in FIGS. 11A and 11B by ψ. A linear solver circuit 516 may receive the basis vector matrix ψ and a corresponding observed vector y_matrix generated from the memory buffer 508. The linear solver circuit 516 may generate and/or solve a system of linear equations equivalent to ψ*h=y, where h is the coefficient vector for the DPD circuit 100. A linear, memoryless term h₁(0) of the coefficient vector h may be provided to the linear DPD circuit 202. The other coefficients of the coefficient vector h may be provided to the DPD actuator circuit 210 to be used as FIR filter coefficients and/or to a LUT construction circuit 518, which may utilize the coefficient vector h to generate LUTs 252a, 252b, 252i, for example, as described above with respect to Equation [7].

In the example of FIGS. 11A and 11B, the training circuit the basis vector matrix ψ is generated from an output of the DPD actuator circuit 210. In some examples, the example configuration shown in FIGS. 11A and 11B could also be configured to generate the basis vector matrix ψ from an input of the DPD actuator circuit 210, for example, similar to the example of FIG. 12.

In the examples of FIGS. 11A and 11B, the tilt reference filter 352 and tilt equalizer 354 are implemented in the DPD circuit 102, for example, at the higher sampling frequency fₛ, and therefore higher clocking frequency, than is implemented after the interpolator circuit 206. In some examples, however, the tilt reference filter 352 and/or tilt equalizer 354 may be positioned at any suitable position in the DPD circuit 102.

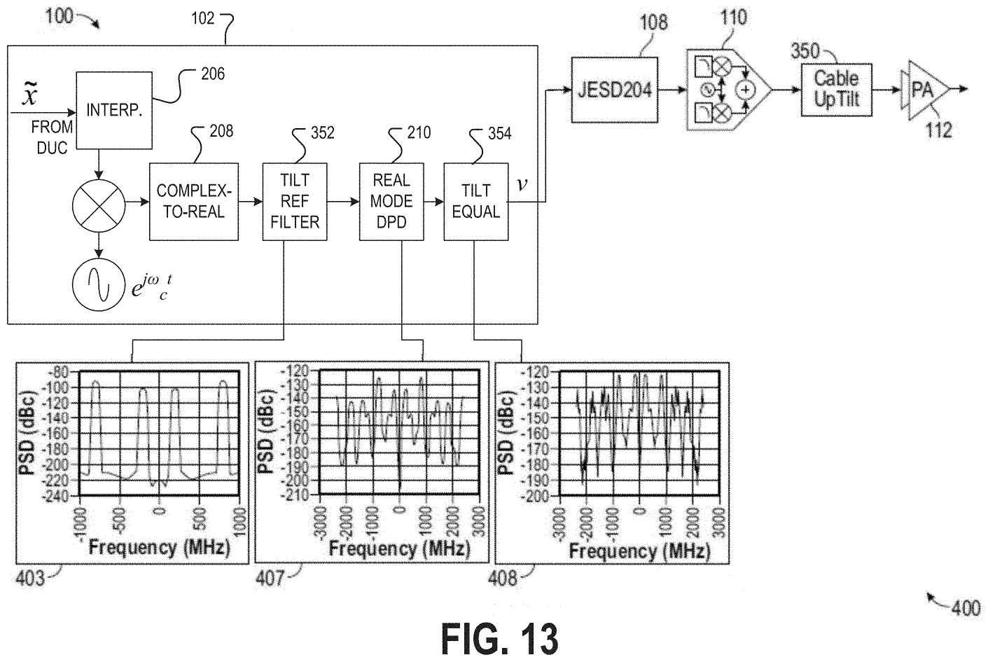

FIGS. 12-13 are a diagram showing the PA circuit 100 in the example configuration of FIG. 9 including modeled power spectral densities at various positions in the circuit 100. A plot 401 shows the power spectral density of the example complex baseband signal \tilde{x}. The example complex baseband signal \tilde{x} comprises two frequency components, one centered at about 300 MHz and another centered at about −300 MHz. A plot 403 shows an input to the DPD actuator circuit 210. The input shown at plot 403 may be an up-sampled real-mode signal with frequency content centered at 200 MHz, 800 MHz, −200 MHz, and −800 MHz. The input shown at the plot 403 may have been processed by the interpolator circuit 206 the mixer 218, the complex-to-real circuit 208, and the tilt reference filter 352. For example, the bandwidth of the input signal shown in plot 403 is between about −900 MHz and 900 MHz, or about 1.8 GHz, which is more than double the bandwidth of the complex baseband signal \tilde{x}. Also, the input signal shown in plot 403 is a real signal, with instances of the frequency components of the complex baseband signal \tilde{x} both in the real and complex frequency domains. The input of the plot 403 also demonstrates tilt filtering. For example, the peaks of the frequency components in the positive frequency domain are tilted up to the right. A plot 407 shows an example predistorted signal v prior to tilt equalizing and complex conversion. A plot 408 shows an example of the predistorted signal v after tilt equalizing.

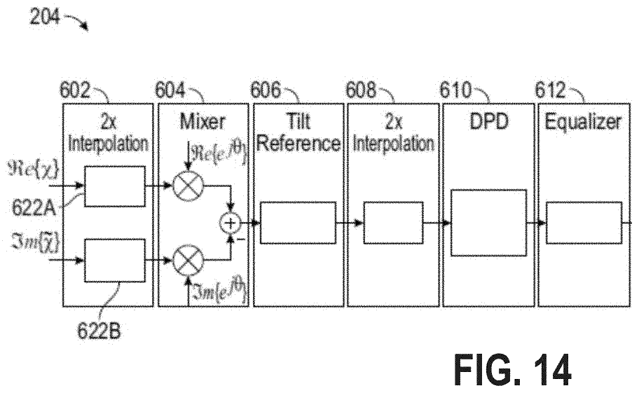

FIG. 14 is a diagram showing an example implementation of the DPD circuit 102 including an alternate component configuration. In the example of FIG. 19, a four times (4×) multirate factor is used. Interpolation is performed in two stages, a first stage interpolator circuit 602 and a second stage interpolator circuit 608. The first stage interpolator circuit 602 includes two one-half (½) band finite impulse response (FIR) filters 622A, 622B. For example, the FIR 622A may receive the real portion of the complex baseband signal \tilde{x} while the FIR 622B may receive the imaginary or quadrature portion of the complex baseband signal \tilde{x}. The second stage interpolator circuit 608 may comprise a single FIR. For example, the second stage interpolator circuit 608 may be positioned after the complex baseband signal is converted to a real signal. Each interpolator stage circuit 602, 608 may increase the sampling frequency or bandwidth of the incoming signal by a factor of two (2×), resulting in a total bandwidth increase to four times (4×) the bandwidth of the complex baseband signal \tilde{x}.

Interposed between the first and second stage interpolator circuits 608 are a mixer circuit 604 and an optional tilt reference circuit 606. The mixer circuit 604 may multiply the respective outputs of the FIRs 622A, 622B by the carrier frequency and sum the results. The output of the mixer circuit 604 may be a real equivalent of the complex baseband signal, shifted by the carrier frequency. The optional tilt reference filter circuit 606 and optional tilt equalizer circuit 612 may operate, for example, as described herein with respect to the circuits 352, 354 described herein. The real DPD circuit 610 may function in a manner similar to the DPD actuator circuit 210 described herein.

### Various Notes & Examples

Example 1 is a system comprising: a digital predistortion (DPD) circuit programmed to generate a predistorted signal based at least in part on a complex baseband signal.

In Example 2, the subject matter of Example 1 optionally includes a complex-to-real circuit programmed to determine a real component based at least in part on the complex baseband signal.

In Example 3, the subject matter of any one or more of Examples 1-2 optionally include an interpolator circuit to up-sample the complex baseband signal to generate an up-sampled complex baseband signal; and an up-converter circuit to translate the up-sampled complex baseband signal to a carrier frequency to generate an up-converted complex signal, wherein the DPD circuit is also to generate the predistorted signal based at least in part on the up-converted complex signal.

In Example 4, the subject matter of any one or more of Examples 1-3 optionally include wherein the DPD circuit is also programmed to: determine a real component based at least in part on the complex baseband signal; determine a first value for the real component at a first time; and select from a first nonlinear look up table (LUT) a first LUT value based at least in part on the first value for the real component, wherein the first LUT value is a based at least in part on a sum of terms omitting a first order term.

In Example 5, the subject matter of Example 4 optionally includes wherein the DPD circuit is also programmed to: select from a second LUT a second LUT value based at least in part on a second value for the real component at a second time before the first time; and determine a sum of the first LUT value and the second LUT value, wherein the predistorted signal is based at least in part on the sum.

In Example 6, the subject matter of any one or more of Examples 1-5 optionally include wherein the DPD circuit is also programmed to: determine a real component based at least in part on the complex baseband signal; determine a first value for the real component at a first time; determine an Ith order power of the first value; apply an Ith order tap coefficient to the Ith order power of the first value to generate an Ith order tap value; determine a Jth order power of the first value; and apply a Jth order tap coefficient to the Jth order power of the first value to generate a Jth order tap value, wherein the real-mode predistorted signal is based at least in part a sum of the Ith order tap value and the Jth order tap value.

In Example 7, the subject matter of any one or more of Examples 1-6 optionally include wherein the DPD circuit is further programmed to: determine a real-mode predistorted nonlinear component; and convert the real-mode predistorted nonlinear component to a complex predistorted nonlinear component.

In Example 8, the subject matter of Example 7 optionally includes wherein the DPD circuit is further programmed to translate the complex predistorted nonlinear component to baseband.

In Example 9, the subject matter of any one or more of Examples 1-8 optionally include a tilt reference filter circuit to apply a highpass frequency gain characteristic to a real component of the complex baseband signal to generate a tilt reference real component, wherein the DPD circuit is also programmed to determine a tilt reference real predistorted signal based at least in part on the tilt reference real component.

Example 10 is a method comprising: receiving a complex baseband signal; generating a predistorted signal component based at least in part on the complex baseband signal.

In Example 11, the subject matter of Example 10 optionally includes determining a real component based at least in part on the complex baseband signal.

In Example 12, the subject matter of any one or more of Examples 10-11 optionally include up-sampling the complex baseband signal to generate an up-sampled complex baseband signal; and translating the up-sampled complex baseband signal to a carrier frequency to generate an up-converted complex signal, wherein generating the predistorted signal is also based at least in part on the up-converted complex signal.

In Example 13, the subject matter of any one or more of Examples 10-12 optionally include determining a real component based at least in part on the complex baseband signal; determining a first value for the real component at a first time; and selecting from a first nonlinear look up table (LUT) a first LUT value based at least in part on the first value for the real component, wherein the first LUT value is a based at least in part on a sum of terms omitting a first order term.

In Example 14, the subject matter of Example 13 optionally includes selecting from a second LUT a second LUT value based at least in part on a second value for the real component at a second time before the first time; and determining a sum of the first LUT value and the second LUT value, wherein the real-mode predistorted signal is based at least in part on the sum.

In Example 15, the subject matter of any one or more of Examples 10-14 optionally include determining a real component based at least in part on the complex baseband signal; determining a first value for the real component at a first time; determining an Ith order power of the first value; applying an Ith order tap coefficient to the Ith order power of the first value to generate an Ith order tap value; determining a Jth order power of the first value; and applying a Jth order tap coefficient to the Jth order power of the first value to generate a Jth order tap value, wherein the real-mode predistorted signal is based at least in part a sum of the Ith order tap value and the Jth order tap value.

In Example 16, the subject matter of any one or more of Examples 10-15 optionally include applying a highpass frequency gain characteristic to a real component of the complex baseband signal to generate a tilt reference real component; determining a tilt reference real real-mode predistorted signal based at least in part on the tilt reference real component; and applying a tilt equalizer to the tilt reference real predistorted signal to generate the real real-mode predistorted signal.

Example 17 is a system comprising: a digital predistortion (DPD) circuit configured to perform operations comprising: receiving a real-mode signal, the real-mode signal comprising a linear portion and a nonlinear portion; and generating a real-mode predistorted signal based at least in part on the real-mode signal.

In Example 18, the subject matter of Example 17 optionally includes a complex-to-real circuit programmed to perform operations comprising: receiving a complex baseband signal; and generating the real-mode signal using the complex baseband signal.

In Example 19, the subject matter of Example 18 optionally includes wherein the DPD circuit is configured to correct for at least one harmonic distortion term having an order greater than or equal to three and wherein the complex baseband signal has a fractional bandwidth greater than about ½.

In Example 20, the subject matter of any one or more of Examples 17-19 optionally includes an interpolator circuit configured to perform operations comprising: receiving a complex baseband signal; and up-sampling the complex baseband signal to generate an up-sampled complex baseband signal, wherein the predistorted signal is based at least in part on the up-sampled complex baseband signal.

In Example 21, the subject matter of Example 20 optionally includes an up-converter circuit configured to translate the up-sampled complex baseband signal to a carrier frequency to generate an up-converted complex signal, wherein the DPD circuit is to generate the predistorted signal based at least in part on the up-converted complex signal.

In Example 22, the subject matter of any one or more of Examples 17-21 optionally includes the DPD circuit further configured to perform operations comprising: determining a first value for the real-mode signal at a first time; and selecting from a first nonlinear look up table (LUT) a first LUT value based at least in part on the first value for the real-mode signal, wherein the first LUT value is a based at least in part on a sum of terms omitting a first order term.

In Example 23, the subject matter of Example 22 optionally includes the DPD circuit further configured to perform operations comprising selecting from a second LUT a second LUT value based at least in part on a second value for the real-mode signal at a second time before the first time; and determining a sum of the first LUT value and the second LUT value, wherein the real-mode predistorted signal is based at least in part on the sum.

In Example 24, the subject matter of any one or more of Examples 17-23 optionally includes the DPD circuit further configured to perform operations comprising: determining a first value for the real-mode signal at a first time; determining an Ith order power of the first value; apply an Ith order tap coefficient to the Ith order power of the first value to generate an Ith order tap value; determining a Jth order power of the first value; and applying a Jth order tap coefficient to the Jth order power of the first value to generate a Jth order tap value, wherein the real-mode predistorted signal is based at least in part a sum of the Ith order tap value and the Jth order tap value.

In Example 25, the subject matter of any one or more of Examples 17-24 optionally includes a tilt reference filter circuit configured to apply a highpass frequency gain characteristic to the real-mode signal to generate a tilt reference real-mode signal, wherein the DPD circuit is also programmed to determine a tilt reference real-mode predistorted signal based at least in part on the tilt reference real-mode signal.

Example 26 is a method comprising: receiving, by a digital predistortion (DPD) circuit, a real-mode signal, the real-mode signal comprising a linear portion and a nonlinear portion; and generating, by the DPD circuit, a real-mode predistorted signal based at least in part on the real-mode signal.

In Example 27, the subject matter of Example 26 optionally includes receiving, by a complex-to-real circuit, a complex baseband signal; and generating the real-mode signal, by the complex-to-real circuit, using the complex baseband signal.

In Example 28, the subject matter of Example 27 optionally includes correcting, by the DPD circuit, for at least one harmonic distortion term having an order greater than or equal to three and wherein the complex baseband signal has a fractional bandwidth greater than about ½.

In Example 29, the subject matter of any one or more of Examples 26-28 optionally includes receiving, by an interpolator circuit, a complex baseband signal; and up-sampling the complex baseband signal to generate an up-sampled complex baseband signal, wherein the predistorted signal is based at least in part on the up-sampled complex baseband signal.

In Example 30, the subject matter of Example 29 optionally includes translating, by an up-converter circuit, the up-sampled complex baseband signal to a carrier frequency to generate an up-converted complex signal, wherein the predistorted signal is based at least in part on the up-converted complex signal.

In Example 31, the subject matter of any one or more of Examples 26-30 optionally includes determining, by the DPD circuit, a first value for the real-mode signal at a first time; and selecting, by the DPD circuit and from a first nonlinear look up table (LUT), a first LUT value based at least in part on the first value for the real-mode signal, wherein the first LUT value is a based at least in part on a sum of terms omitting a first order term.

In Example 32, the subject matter of Example 31 optionally includes selecting, by the DPD circuit and from a second LUT, a second LUT value based at least in part on a second value for the real-mode signal at a second time before the first time; and determining, by the DPD circuit, a sum of the first LUT value and the second LUT value, wherein the real-mode predistorted signal is based at least in part on the sum.

In Example 33, the subject matter of any one or more of Examples 26-32 optionally includes determining a first value for the real-mode signal at a first time; determining an Ith order power of the first value; apply an Ith order tap coefficient to the Ith order power of the first value to generate an Ith order tap value; determining a Jth order power of the first value; and applying a Jth order tap coefficient to the Jth order power of the first value to generate a Jth order tap value, wherein the real-mode predistorted signal is based at least in part a sum of the Ith order tap value and the Jth order tap value.

In Example 34, the subject matter of any one or more of Examples 26-33 optionally includes applying a highpass frequency gain characteristic to the real-mode signal to generate a tilt reference real-mode signal; and determining a tilt reference real-mode predistorted signal based at least in part on the tilt reference real-mode signal.

Example 35 is a system comprising: means for receiving a real-mode signal, the real-mode signal comprising a linear portion and a nonlinear portion; and means for generating a real-mode predistorted signal based at least in part on the real-mode signal.

In Example 36, the subject matter of Example 35 optionally includes means for receiving a complex baseband signal; and means for generating the real-mode signal using the complex baseband signal.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The term “circuit” can include a dedicated hardware circuit, a general-purpose microprocessor, digital signal processor, or other processor circuit, and may be structurally configured from a general purpose circuit to a specialized circuit such as using firmware or software.

Any one or more of the techniques (e.g., methodologies) discussed herein may be performed on a machine. In various embodiments, the machine may operate as a standalone device or may be connected (e.g., networked) to other machines. In a networked deployment, the machine may operate in the capacity of a server machine, a client machine, or both in server-client network environments. In an example, the machine may act as a peer machine in peer-to-peer (P2P) (or other distributed) network environment. The machine may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions can enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Particular implementations of the systems and methods described herein may involve use of a machine (e.g., computer system) that may include a hardware processor (e.g., a central processing unit (CPU), a graphics processing unit (GPU), a hardware processor core, or any combination thereof), a main memory and a static memory, some or all of which may communicate with each other via an interlink (e.g., bus). The machine may further include a display unit, an alphanumeric input device (e.g., a keyboard), and a user interface (UI) navigation device (e.g., a mouse). In an example, the display unit, input device and UI navigation device may be a touch screen display. The machine may additionally include a storage device (e.g., drive unit), a signal generation device (e.g., a speaker), a network interface device, and one or more sensors, such as a global positioning system (GPS) sensor, compass, accelerometer, or other sensor. The machine may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device may include a machine readable medium on which is stored one or more sets of data structures or instructions (e.g., software) embodying or utilized by any one or more of the techniques or functions described herein. The instructions may also reside, completely or at least partially, within the main memory, within static memory, or within the hardware processor during execution thereof by the machine. In an example, one or any combination of the hardware processor, the main memory, the static memory, or the storage device may constitute machine readable media.

While the machine readable medium can include a single medium, the term “machine readable medium” may include a single medium or multiple media (e.g., a centralized or distributed database, and/or associated caches and servers) configured to store the one or more instructions.

The term “machine readable medium” may include any medium that is capable of storing, encoding, or carrying instructions for execution by the machine and that cause the machine to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device may include one or more physical jacks (e.g., Ethernet, coaxial, or phone jacks) or one or more antennas to connect to the communications network. In an example, the network interface device may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine, and includes digital or analog communications signals or other intangible medium to facilitate communication of such software.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A system comprising:
a digital predistortion (DPD) circuit configured to perform operations comprising:
receiving a real-mode signal, the real-mode signal comprising a linear portion and a nonlinear portion; and
generating a real-mode predistorted signal based at least in part on the real-mode signal.

2. The system of claim 1, further comprising a complex-to-real circuit programmed to perform operations comprising:
receiving a complex baseband signal; and
generating the real-mode signal using the complex baseband signal.

3. The system of claim 2, wherein the DPD circuit is configured to correct for at least one harmonic distortion term having an order greater than or equal to three and wherein the complex baseband signal has a fractional bandwidth greater than about ½.

4. The system of claim 1, further comprising:
an interpolator circuit configured to perform operations comprising:
receiving a complex baseband signal; and
up-sampling the complex baseband signal to generate an up-sampled complex baseband signal, wherein the predistorted signal is based at least in part on the up-sampled complex baseband signal.

5. The system of claim 4, further comprising an up-converter circuit configured to translate the up-sampled complex baseband signal to a carrier frequency to generate an up-converted complex signal, wherein the DPD circuit is to generate the predistorted signal based at least in part on the up-converted complex signal.

6. The system of claim 1, the DPD circuit further configured to perform operations comprising:
determining a first value for the real-mode signal at a first time; and
selecting from a first nonlinear look up table (LUT) a first LUT value based at least in part on the first value for the real-mode signal, wherein the first LUT value is a based at least in part on a sum of terms omitting a first order term.

7. The system of claim 6, the DPD circuit further configured to perform operations comprising
selecting from a second LUT a second LUT value based at least in part on a second value for the real-mode signal at a second time before the first time; and
determining a sum of the first LUT value and the second LUT value, wherein the real-mode predistorted signal is based at least in part on the sum.

8. The system of claim 1, the DPD circuit further configured to perform operations comprising:
determining a first value for the real-mode signal at a first time;
determining an Ith order power of the first value;
apply an Ith order tap coefficient to the Ith order power of the first value to generate an Ith order tap value;
determining a Jth order power of the first value; and
applying a Jth order tap coefficient to the Jth order power of the first value to generate a Jth order tap value, wherein the real-mode predistorted signal is based at least in part a sum of the Ith order tap value and the Jth order tap value.

9. The system of claim 1, further comprising a tilt reference filter circuit configured to apply a highpass frequency gain characteristic to the real-mode signal to generate a tilt reference real-mode signal, wherein the DPD circuit is also programmed to determine a tilt reference real-mode predistorted signal based at least in part on the tilt reference real-mode signal.

10. A method comprising:
receiving, by a digital predistortion (DPD) circuit, a real-mode signal, the real-mode signal comprising a linear portion and a nonlinear portion; and
generating, by the DPD circuit, a real-mode predistorted signal based at least in part on the real-mode signal.

11. The method of claim 10, further comprising:
receiving, by a complex-to-real circuit, a complex baseband signal; and
generating the real-mode signal, by the complex-to-real circuit, using the complex baseband signal.

12. The method of claim 11, further comprising correcting, by the DPD circuit, for at least one harmonic distortion term having an order greater than or equal to three and wherein the complex baseband signal has a fractional bandwidth greater than about ½.

13. The method of claim 10, further comprising:
receiving, by an interpolator circuit, a complex baseband signal; and
up-sampling the complex baseband signal to generate an up-sampled complex baseband signal, wherein the predistorted signal is based at least in part on the up-sampled complex baseband signal.

14. The method of claim 13, further comprising:
translating, by an up-converter circuit, the up-sampled complex baseband signal to a carrier frequency to generate an up-converted complex signal, wherein the predistorted signal is based at least in part on the up-converted complex signal.

15. The method of claim 10, further comprising:
determining, by the DPD circuit, a first value for the real-mode signal at a first time; and
selecting, by the DPD circuit and from a first nonlinear look up table (LUT), a first LUT value based at least in part on the first value for the real-mode signal, wherein the first LUT value is a based at least in part on a sum of terms omitting a first order term.

16. The method of claim 15, further comprising:
selecting, by the DPD circuit and from a second LUT, a second LUT value based at least in part on a second value for the real-mode signal at a second time before the first time; and
determining, by the DPD circuit, a sum of the first LUT value and the second LUT value, wherein the real-mode predistorted signal is based at least in part on the sum.

17. The method of claim 10, further comprising:
determining a first value for the real-mode signal at a first time;
determining an Ith order power of the first value;
apply an Ith order tap coefficient to the Ith order power of the first value to generate an Ith order tap value;
determining a Jth order power of the first value; and
applying a Jth order tap coefficient to the Jth order power of the first value to generate a Jth order tap value, wherein the real-mode predistorted signal is based at least in part a sum of the Ith order tap value and the Jth order tap value.

18. The method of claim 10, further comprising:
applying a highpass frequency gain characteristic to the real-mode signal to generate a tilt reference real-mode signal; and
determining a tilt reference real-mode predistorted signal based at least in part on the tilt reference real-mode signal.

19. A system comprising:
means for receiving a real-mode signal, the real-mode signal comprising a linear portion and a nonlinear portion; and
means for generating a real-mode predistorted signal based at least in part on the real-mode signal.

20. The system of claim 19, further comprising:
means for receiving a complex baseband signal; and
means for generating the real-mode signal using the complex baseband signal.
